(19) United States
(12) Patent Application Publication
(10) Pub. No.: US 2021/0374972 A1
(43) Pub. Date: Dec. 2, 2021

(54) PANORAMIC VIDEO DATA PROCESSING METHOD, TERMINAL, AND STORAGE MEDIUM

(71) Applicant: HUAWEI TECHNOLOGIES CO., LTD., Shenzhen (CN)

(72) Inventors: Xin XIN, Shenzhen (CN); Zhixiong LU, Shenzhen (CN); Yasong HUANG, Beijing (CN); Xueyan HUANG, Shenzhen (CN); Weixi ZHENG, Shenzhen (CN)

(21) Appl. No.: 17/405,734

(22) Filed: Aug. 18, 2021

Related U.S. Application Data
(63) Continuation of application No. PCT/CN2020/075878, filed on Feb. 19, 2020.

(30) Foreign Application Priority Data
Feb. 20, 2019 (CN) 201910130852.5

(51) Int. Cl. G06T 7/20; G06T 7/70; G06T 7/593

(52) U.S. Cl. CPC G06T 7/20; G06T 2207/10016; G06T 7/593; G06T 7/70

(57) ABSTRACT

This disclosure provides a panoramic video data processing method, a terminal, and a storage medium, to improve efficiency for inserting three-dimensional data corresponding to a tracked object, and quickly add a 3D element. The panoramic video data processing method, the terminal, and the storage medium may be applied to the virtual reality (VR), augmented reality (AR), or mixed reality (MR) field. The method includes: obtaining a first sample frame in panoramic video data; determining at least one key object in the first sample frame; obtaining input data; determining a tracked object in the at least one key object based on the input data; obtaining three-dimensional location information of the tracked object in the panoramic video data; and adding tracking data for the tracked object based on the three-dimensional location information.

### CROSS-REFERENCE TO RELATED APPLICATIONS

This application is a continuation of International Application No. PCT/CN2020/075878, filed on Feb. 19, 2020, which claims priority to Chinese Patent 201910130852.5, filed on Feb. 20, 2019. The disclosures of the aforementioned applications are hereby incorporated by reference in their entireties.

### TECHNICAL FIELD

This disclosure relates to the image processing field, and in particular, to a panoramic video data processing method, a terminal, and a storage medium.

### BACKGROUND

A panoramic video is obtained by performing synchronization, combination, splicing, and the like on a plurality of pieces of video data collected by a plurality of cameras. The panoramic video may be played in a three-dimensional (3D) form. A user may watch the panoramic video by using a 3D device, for example, a virtual reality (VR), augmented reality (AR), or mixed reality (MR) head-mounted display device. During production of the panoramic video, 3D data usually should be added to video content. For example, an audio source, a letter, and a special effect can be played or displayed in a three-dimensional form. When the 3D data is added to the panoramic video, the data usually should be added to a corresponding location in three-dimensional space. However, if an object to which the data should be added is in a moving state in the panoramic video, the data should be added to a plurality of frames. This requires a large workload for processing.

Usually, for processing of the panoramic video, reference may be made to a manner of processing a two-dimensional video. A moving object is tracked by using key frames. Each frame with a large movement of the object serves as a key frame. 3D data is aligned with the tracked object, to track the moving object and add the 3D data to the object.

However, when 3D data is added by using key frames, when an object moves irregularly, a large quantity of key frames should be determined, and the 3D data should be aligned with the object at each key frame. This causes a large workload and comparatively low efficiency. Therefore, how to improve efficiency for identifying an object in a panoramic video becomes a problem that urgently needs to be resolved.

### SUMMARY

This disclosure provides a panoramic video data processing method, to improve efficiency for inserting three-dimensional data corresponding to a tracked object, and quickly add a 3D element.

In view of this, an embodiment of this disclosure provides a panoramic video data processing method, including:

obtaining a first sample frame in panoramic video data; determining at least one key object in the first sample frame; obtaining input data; determining a tracked object in the at least one key object based on the input data, where the tracked object corresponds to tracking data; obtaining three-dimensional location information of the tracked object in the panoramic video data; and adding the tracking data for the tracked object based on the three-dimensional location information. In an embodiment of this disclosure, after any frame in the panoramic video data is obtained as the first sample frame, the at least one key object may be determined in the first sample frame, and the input data may be obtained. The tracked object in the at least one key object is determined by using the input data, and the tracked object has the corresponding tracking data. Then after the tracked object is determined, the three-dimensional location information of the tracked object is determined in the panoramic video data. The three-dimensional location information may include a three-dimensional location of the tracked object in all frames in the panoramic video data, and the tracking data of the tracked object is added based on the three-dimensional location information, so that a correspondence is established between the tracking data and the three-dimensional location of the tracked object in the panoramic video data. Therefore, 3D data does not need to be aligned with an object at each key frame. After the at least one key object is identified, a user may determine the tracked object, and then the tracking data may be automatically added to the panoramic video for the tracked object. This improves efficiency for adding the tracking data for the tracked object.

In an embodiment, the obtaining three-dimensional location information of the tracked object in the panoramic video data may include:

determining coordinates of the tracked object in the panoramic video data; determining a depth value of the tracked object based on the coordinates of the tracked object in the panoramic video data; and determining the three-dimensional location information of the tracked object in the panoramic video data based on depth information and the coordinates of the tracked object in the panoramic video data.

In this embodiment of this disclosure, after the tracked object is determined, the coordinates of the tracked object in the panoramic video data may be first determined, and then calculation is performed based on the coordinates of the tracked object in the panoramic video data to determine the depth value of the tracked object in the panoramic video data. Usually, the depth value is a distance from the tracked object to a virtual camera. The three-dimensional location information of the tracked object in the panoramic video data may be determined based on the depth value and the coordinates of the tracked object in the panoramic video data. Therefore, the three-dimensional location information of the tracked object may be automatically calculated based on the coordinates of the tracked object. In this way, a location of the tracked object is determined more efficiently, and in turn related data is added for the tracked object more efficiently.

In an optional embodiment, the determining a depth value of the tracked object may include:

extracting the depth information based on a pixel value in the panoramic video data; and determining the depth value of the tracked object based on the depth information.

In this embodiment of this disclosure, the depth value of the tracked object is retained in the panoramic video data. Therefore, the depth information of the tracked object may be directly extracted based on the pixel value in the panoramic video data according to a preset rule, and the depth value of the tracked object may be determined based on the depth information. Therefore, when the depth information in retained in the panoramic video data, the pixel value of the tracked object in the panoramic video data may be determined based on the coordinates of the tracked object in the panoramic video data, and in turn the depth value of the tracked object may be determined according to the preset rule. This can quickly and accurately determine the depth value of the tracked object, and in turn determine a three-dimensional location of the tracked object.

In an optional embodiment, the determining a depth value of the tracked object may include:

determining an offset between a left-eye-view image of the tracked object in the panoramic video data and a right-eye-view image of the tracked object in the panoramic video data; and calculating the depth value of the tracked object based on the offset.

In this embodiment of this disclosure, the depth value of the tracked object may be calculated based on the offset between the left-eye-view image and the right-eye-view image of the tracked object. Therefore, even if the depth information of the tracked object is not retained in the panoramic video data, the depth value of the tracked object can be accurately calculated, and in turn the three-dimensional location of the tracked object can be determined.

In an optional embodiment, the determining an offset between a left-eye-view image of the tracked object in the panoramic video data and a right-eye-view image of the tracked object in the panoramic video data may include:

determining an offset corresponding to each pixel of the tracked object in the left-eye-view image in the panoramic video data and the right-eye-view image in the panoramic video data.

The calculating the depth value of the tracked object based on the offset may include:

calculating each depth sub-value corresponding to each pixel based on the offset corresponding to each pixel; and performing a weighting operation on each depth sub-value to obtain the depth value of the tracked object.

In this embodiment of this disclosure, the offset corresponding to each pixel of the tracked object in the left-eye-view image in the panoramic video data and the right-eye-view image in the panoramic video data may be determined; the depth sub-value corresponding to each pixel of the tracked object may be calculated based on the offset corresponding to each pixel; and the weighting operation may be performed on each depth sub-value to obtain the depth value of the tracked object. Therefore, in this embodiment of this disclosure, the weighting operation may be performed on the depth sub-value corresponding to each pixel of the tracked object to determine the depth value of the tracked object, so that the obtained depth value is more accurate.

In an optional embodiment, the performing a weighting operation on each depth sub-value to obtain the depth value of the tracked object may include:

determining at least one pixel corresponding to a preset feature of the tracked object; determining a first weight value corresponding to the at least one pixel, and a second weight value corresponding to a pixel other than the at least one pixel of the tracked object, where the first weight value is greater than the second weight value; and calculating the depth value of the tracked object based on the first weight value, the second weight value, and the depth sub-value.

In this embodiment of this disclosure, the first weight value corresponding to the at least one pixel of a part of the tracked object may be determined, and the second weight value corresponding to the other part of pixels may be determined, where the first weight value is greater than the second weight value; and then the depth value of the tracked object is calculated based on the first weight value, the second weight value, and the depth sub-value corresponding to each pixel. Therefore, the first weight value of a more distinct feature of the tracked object is greater than the second weight value, making the calculated depth value of the tracked object more accurate.

In addition, in an optional embodiment, the first weight value may be alternatively equal to the second weight value. In this case, an averaging operation is directly performed on the depth sub-values to obtain the depth value of the tracked object.

In an optional embodiment, the determining at least one key object in the first sample frame may include:

generating at least one sub-image corresponding to the first sample frame; and identifying objects in each of the at least one sub-image to obtain the at least one key object corresponding to the first sample frame.

In this embodiment of this disclosure, the first sample frame may be divided into the at least one sub-image, objects in the at least one sub-image may be identified, and the at least one key object may be determined from the objects in the at least one sub-image. Therefore, the first sample frame may be divided, and objects may be separately identified. After the objects in the at least one sub-image are identified, a key object may be determined based on the preset feature.

In an optional embodiment, the generating at least one sub-image corresponding to the first sample frame may include:

generating a left-view three-dimensional panoramic image based on a left-eye-view image in the first sample frame, and generating a right-view three-dimensional panoramic image based on a right-eye-view image in the first sample frame; and capturing a sub-image from the left-view three-dimensional panoramic image or the right-view three-dimensional panoramic image according to a preset rule, to obtain the at least one sub-image.

In this embodiment of this disclosure, the first sample frame may be divided into a left-eye-view image and a right-eye-view image, a three-dimensional panoramic image is restored based on either the left-eye-view image or the right-eye-view image, and a sub-image is captured from the three-dimensional panoramic image according to the preset rule, to obtain the at least one image. In other words, the sub-image is directly captured from the restored three-dimensional panoramic image. Compared with directly identifying the first sample frame, capturing from restoration can improve accuracy for identifying an object, and avoid an identification error caused by image distortion.

In an optional embodiment, the identifying objects in each of the at least one sub-image to obtain the at least one key object corresponding to the first sample frame may include:

identifying the objects included in each of the at least one sub-image; and determining, based on a preset condition, the at least one key object in the objects included in each sub-image. In this embodiment of this disclosure, after the objects included in each of the at least one sub-image are identified, the at least one key object is selected, based on the preset condition, from the objects included in each sub-image. This can improve accuracy for identifying a key object, and avoid identifying excessive meaningless objects, thereby improving user experience.

In an optional embodiment, before the generating at least one sub-image corresponding to the first sample frame, the method may further include:

determining every N^{th} frame in the panoramic video data as a sample frame, to obtain at least one sample frame, where N is a positive integer, and the first sample frame is any one of the at least one sample frame.

In this embodiment of this disclosure, before the first sample frame is determined, the at least one sample frame may be extracted from the panoramic video data. A specific manner may be determining every N^{th} frame as a sample frame. Then any one of the at least one sample frame is determined as the first sample frame. Therefore, by determining a sample frame, this can improve efficiency for identifying a key object.

In an optional embodiment, the method further includes:

generating prompt information for a first key object, where the first key object is prompt information for any one of the at least one key object; and displaying the prompt information.

In this embodiment of this disclosure, after the key object is identified, the related prompt information may be generated for the first key object, and the prompt information may be displayed. Therefore, a user may obtain related information of the first key object based on the prompt information, thereby improving user experience.

An embodiment of this disclosure provides a terminal. The terminal has a function of implementing the panoramic video data processing method in various embodiments. The function may be implemented by hardware, or may be implemented by hardware executing corresponding software. The hardware or software includes one or more modules corresponding to the function.

An embodiment of this disclosure provides a graphical user interface GUI. The graphical user interface is stored in a terminal. The terminal includes a display screen, one or more memories, and one or more processors. The one or more processors are configured to execute one or more computer programs stored in the one or more memories. The graphical user interface may include the image described in any embodiment of the panoramic video data processing methods described herein.

An embodiment of the embodiments of this disclosure provides a terminal. The terminal may include:

a processor, a memory, and an input/output interface, where the processor, the memory, and the input/output interface are connected, the memory is configured to store program code, and when invoking the program code in the memory, the processor performs the operations of the method provided in various embodiments this disclosure.

An embodiment of this disclosure provides a chip system. The chip system includes a processor, configured to support a terminal in implementing the functions described in the foregoing embodiments, for example, processing the data and/or the information described in the foregoing method. In a possible design, the chip system further includes a memory. The memory is configured to store a program instruction and data that are necessary for a network device. The chip system may include a chip, or may include a chip and another discrete device.

The processor mentioned anywhere above may be a general-purpose central processing unit (CPU), a microprocessor, an application-specific integrated circuit (ASIC), or one or more integrated circuits configured to control execution of a program for the panoramic video data processing method in the embodiments described herein.

An embodiment of the embodiments of this disclosure provides a storage medium. It should be noted that the technical solutions of the present disclosure essentially, or the part contributing to the prior art, or all or some of the technical solutions may be implemented in a form of a software product. The computer software product is stored in a storage medium, and is configured to store a computer software instruction for use by the foregoing device. The computer software product includes a program designed for a terminal for performing any of the embodiments described herein.

The storage medium includes any medium that can store program code, for example, a USB flash drive, a removable hard disk, a read-only memory (ROM), a random access memory (RAM), a magnetic disk, or an optical disc.

An embodiment of this disclosure provides a computer program product including an instruction. When the computer program product runs on a computer, the computer is enabled to perform the method in any of the embodiments described herein.

In this disclosure, after any frame in the panoramic video data is obtained as the first sample frame, the at least one key object may be determined in the first sample frame, and the input data may be obtained. The tracked object in the at least one key object is determined by using the input data, and the tracked object has the corresponding tracking data. Then after the tracked object is determined, the three-dimensional location information of the tracked object is determined in the panoramic video. The three-dimensional location information may include a three-dimensional location of the tracked object in all frames in the panoramic video data, and the tracking data of the tracked object is added based on the three-dimensional location information, so that a correspondence is established between the tracking data and the three-dimensional location of the tracked object in the panoramic video data. Therefore, in this application, 3D data does not need to be aligned with an object at each key frame. After the at least one key object is identified, a user may determine the tracked object, and then the tracking data may be automatically added to the panoramic video for the tracked object. This improves efficiency for adding the tracking data for the tracked object.

### BRIEF DESCRIPTION OF DRAWINGS

FIG. 1a is a schematic diagram of a left-and-right 3D image according to an embodiment of this disclosure;

FIG. 1b is a schematic diagram of an up-and-down 3D image according to an embodiment of this disclosure;

FIG. 2 is a schematic flowchart of a panoramic video data processing method according to this disclosure;

FIG. 3 is another schematic flowchart of a panoramic video data processing method according to this disclosure;

FIG. 4 is a schematic diagram of panoramic video data including up-and-down 3D data according to an embodiment of this disclosure;

FIG. 5 is a schematic diagram of a left view and a right view according to an embodiment of this disclosure;

FIG. 6a is a schematic diagram of a first sub-image according to an embodiment of this disclosure;

FIG. 6b is a schematic diagram of a second sub-image according to an embodiment of this disclosure;

FIG. 7 is a schematic diagram of a marker box for a key object according to an embodiment of this disclosure;

FIG. 8 is a schematic diagram of prompt information for a key object according to an embodiment of this disclosure;

FIG. 9 is a schematic diagram of a marker box for another key object according to an embodiment of this disclosure;

FIG. 10 is a schematic flowchart of determining a sub-image according to an embodiment of this disclosure;

FIG. 11 is a schematic diagram of a photographing plane of a binocular virtual camera according to an embodiment of this disclosure;

FIG. 12a is a schematic diagram of another first sub-image according to an embodiment of this disclosure;

FIG. 12b is a schematic diagram of another second sub-image according to an embodiment of this disclosure;

FIG. 13 is a schematic diagram of a marker box for another key object according to an embodiment of this disclosure;

FIG. 14 is a schematic diagram of a marker box for another key object according to an embodiment of this disclosure;

FIG. 15a is a schematic diagram of identifying a facial feature according to an embodiment of this disclosure;

FIG. 15b is another schematic diagram of identifying a facial feature according to an embodiment of this disclosure;

FIG. 16 is a schematic diagram of a progress bar according to an embodiment of this disclosure;

FIG. 17 is a schematic structural diagram of a terminal according to an embodiment of this disclosure;

FIG. 18 is another schematic structural diagram of a terminal according to an embodiment of this disclosure; and

FIG. 19 is another schematic structural diagram of a terminal according to an embodiment of this disclosure.

### DESCRIPTION OF EMBODIMENTS

This disclosure provides a panoramic video data processing method, to improve efficiency for inserting three-dimensional data corresponding to a tracked object, and quickly add a 3D element.

In an existing solution, if corresponding data such as a subtitle, audio data, or mosaic should be inserted in panoramic video data, a user needs to manually select key frames. Each frame with a large movement of an object serves as a key frame. 3D data is aligned with a tracked object, to track a moving object and add 3D data to the object. This causes a large workload. Therefore, to improve efficiency for adding corresponding three-dimensional data, this disclosure provides a method for quickly adding three-dimensional tracking data after a tracked object is determined.

Usually, panoramic video data may include a plurality of frames of images. Each frame may include a left-eye-view image and a right-eye-view image. The left-eye-view image and the right-eye-view image may form a left-and-right 3D image or an up-and-down 3D image. In addition, the left-eye-view image corresponds to the right-eye-view image. The left-eye-view image is an image obtained from a left-side view. The right-eye-view image is an image obtained from a right-side view. A distance between a photographing point at which the left-side view is obtained and a photographing point at which the right-side view is obtained may be understood as an inter-pupil distance. Certainly, in addition to the left-and-right 3D image and the up-and-down 3D image, there may be another type of panoramic video data. Description in this disclosure is only illustrative rather than restrictive.

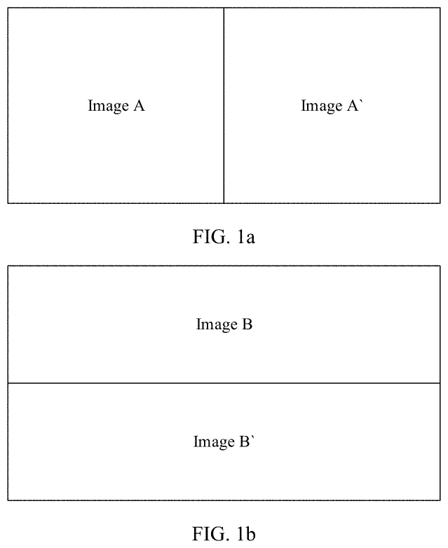

For example, the left-and-right 3D image may be shown in FIG. 1a. A left-side image A is the left-eye-view image, and a right-side image A′ is the right-eye-view image. The up-and-down 3D image may be shown in FIG. 1b. An upper image B is the left-eye-view image, and a lower image B′ is the right-eye-view image. A user may watch a panoramic video by using a 3D display device, for example, a VR, AR, or MR head-mounted display device. A left eye obtains the left-eye-view image. A right eye obtains the right-eye-view image. The left-eye-view image and the right-eye-view image are combined to form a three-dimensional image of the panoramic video for the user. In the panoramic video data processing method provided in this disclosure, any sample frame in panoramic video data includes a left-eye-view image and a right-eye-view image. When an image is displayed, either the left-eye-view image or the right-eye-view image may be displayed.

The panoramic video data processing method provided in this disclosure may be based on a terminal, which may also be referred to as a terminal device. The terminal may be any terminal such as a computer, a tablet computer, a Personal Digital Assistant (PDA), a Point of Sales (POS), or an in-vehicle computer. Systems that can be carried on the terminal may include iOS®, Android®, Microsoft®, Linux®, or other operating systems. This is not limited in the embodiments of this disclosure.

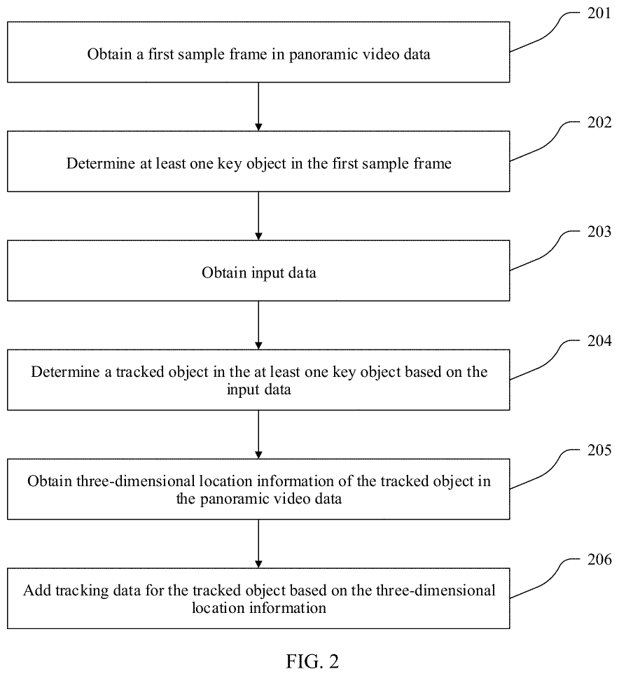

The following describes a process of the panoramic video data processing method provided in this disclosure. FIG. 2 is a schematic flowchart of the panoramic video data processing method provided in this disclosure. The method may include the following operations.

201. Obtain a first sample frame in panoramic video data.

First, the first sample frame in the panoramic video data is obtained. The first sample frame may be any frame of image in the panoramic video data.

In addition, in an optional embodiment of this embodiment of this disclosure, when each frame of image in the panoramic video data is an up-and-down 3D image, a left-and-right 3D image, or the like, the first sample frame may include a left-view image or a right-view image. The left-view image and the right-view image include same objects, and each of the objects included has corresponding location information in both the left-view image and the right-view image. For example, coordinates of an object A in the left-view image are (a, b). In this case, coordinates of the object A in the right-view image may be (a+a′, b+b′). a′ and b′ are offsets between a left view and a right view. Objects with a same feature in the left-eye-view image and the right-eye-view image may be understood as one object. Alternatively, when coordinate axes are established, the left-view image and the right-view image share same coordinate axes. In this case, if coordinates of an object A in the left-view image are (a, b), coordinates of the object A in the right-view image may also be (a, b). A coordinate location of an object may be adjusted based on an actual application scenario. This is not limited in this disclosure.

In an optional embodiment of this disclosure, the panoramic video data may be first sampled to obtain at least one sample frame in the panoramic video data, and then one of the at least one sample frame is determined as the first sample frame. A frame may be randomly determined as the first sample frame, or a user may determine one of the at least one sample frame as the first sample frame. This may be specifically adjusted based on an actual application scenario, and is not limited in this embodiment of this disclosure.

In an optional embodiment of this disclosure, when the at least one sample frame in the panoramic video data is being determined, specifically, every N^{th} frame may be determined as a sample frame, to obtain the at least one sample frame, where N is a positive integer. For example, every Nt^{h} frame in the panoramic video may be determined as a sample frame, to obtain M sample frames, where M is a positive integer.

In an optional embodiment of this disclosure, after the first sample frame is determined, the first sample frame may be displayed. The first sample frame includes the left-eye-view image and the right-eye-view image, and either the left-eye-view image or the right-eye-view image may be displayed.

202. Determine at least one key object in the first sample frame.

After the first sample frame is obtained, the at least one key object in the first sample frame may be determined. For example, the at least one key object may include objects such as a person and a device in the first sample frame.

In addition, after the at least one key object in the first sample frame is determined, if the first sample frame is the left-view image, the right-view image also includes at least one corresponding key object.

Specifically, a specific manner of determining the at least one key object may be as follows: The obtained panoramic video data is usually an expanded image, including an expanded left-eye-view image or right-eye-view image. The left-eye-view image or the right-eye-view image is restored to a three-dimensional panoramic image. For example, the left-eye-view image and the right-eye-view image may be assigned, as stickers, into two spheres with a same size. This is equivalent to restoration to three-dimensional panoramic images in an actual application scenario. Then a corresponding sub-image is captured from the three-dimensional panoramic image from a left-eye view, and a sub-image corresponding to a right-eye view is captured from the right-eye view, to obtain at least one sub-image. A specific angle and range for capturing may be adjusted according to an actual requirement. Then objects included in each of the at least one sub-image are identified by using an identification algorithm, and a key object in the objects included in each of the at least one sub-image is determined based on at least one of a feature, a depth, a distance, and the like of each object. For example, if J articles including K persons are identified, the K persons may be treated as K key objects, where both J and K are positive integers, and J≥K. A specific identification algorithm may include a facial landmark detection (Dlib landmark detection) algorithm, an object detection algorithm, or the like, and may be specifically adjusted based on an actual application scenario.

In an optional embodiment of this disclosure, after the at least one key object in the first sample frame is determined, the at least one key object may be highlighted on display of the first sample frame. For example, a marker box or a marker is generated for each key object. Therefore, in this embodiment of this disclosure, the at least one key object may be highlighted, so that the user can have more direct perception in observing each key object and accurately select a tracked object, to add tracking data more accurately.

203. Obtain input data.

After the at least one key object in the first sample frame is determined, the input data is obtained.

Specifically, the input data may be determined by performing input by the user based on the at least one key object in the first sample frame, or may be determined by identifying the at least one key object. For example, after the at least one key object in the first sample frame is determined, detection is performed on an input operation of the user, and the user performs input based on the at least one key object, to determine a tracked object in the at least one key object, or a tracked object is determined based on an identified key object.

204. Determine a tracked object in the at least one key object based on the input data.

After the input data is obtained, the tracked object in the at least one key object is determined based on the input data, and the tracked object has corresponding tracking data.

Specifically, the input data may be obtained based on input of the user. For example, the at least one key object is highlighted based on display of the first sample frame, and the user may select one of the at least one key object as the tracked object. Alternatively, the input data may be identifying the tracked object based on objects in the first sample frame. After the tracked object is determined, the tracked object has the corresponding tracking data. A correspondence may be preset, or may be obtained based on the input data. For example, if one of the at least one key object is determined as the tracked object, audio data corresponding to the tracked object, that is, the tracking data, may also be determined. Alternatively, after the tracked object is determined, a type of the tracked object may also be determined, and then audio data corresponding to the tracked object is determined based on the type of the tracked object and a preset mapping relationship.

205. Obtain three-dimensional location information of the tracked object in the panoramic video data.

After the tracked object is determined, the three-dimensional location information of the tracked object in the panoramic video data is further obtained. The three-dimensional location information is information about a location of the tracked object in each frame of image in the panoramic video data.

Specifically, after the tracked object is determined, depth information may be further determined based on plane coordinates of the tracked object in the panoramic video data, and the three-dimensional location information of the tracked object in the panoramic video data is determined based on the depth information in combination with the plane coordinates. The three-dimensional location information of the tracked object in the panoramic video data may include plane coordinates and a depth value of the tracked object in each frame in the panoramic video data. The tracked object may be in a moving state in the panoramic video. Therefore, the tracked object may have different plane coordinates and a different depth value in each frame.

The three-dimensional location information may include a three-dimensional location of the tracked object in each frame in the panoramic video data. Usually, the three-dimensional location may be represented by using coordinates, a data list, or the like. Using coordinates as an example, the three-dimensional location of the tracked object in each frame may be represented as (x, y, z), where (x, y) are plane coordinates of the tracked object in each frame of image, and z may be a depth value of the tracked object in each frame of image.

In an optional embodiment of this embodiment of this disclosure, if the panoramic video data further includes depth information, the depth information of the tracked object may be directly extracted from the panoramic video data. For example, after a plane location of the tracked object in a frame of image is determined, a depth value corresponding to the plane location is extracted from preset depth information based on the plane location of the tracked object, and in turn a three-dimensional location of the tracked object in this frame of image is determined.

In an optional embodiment of this embodiment of this disclosure, if the panoramic video data does not include depth information, the depth information of the tracked object may be calculated by using a binocular matching algorithm. Specifically, a calculation manner for the first sample frame is used as an example. First location information of the tracked object is determined in the left-view image of the first sample frame, and second location information of the tracked object is determined in the right-view image of the first sample frame. Then an offset between the left-view image and the right-view image of the tracked object is calculated based on the first location information and the second location information. In addition, the depth value of the tracked object is calculated based on the offset, to obtain the depth information of the tracked object, and further determine the three-dimensional location information of the tracked object. More details are described in the following specific embodiments.

In an optional embodiment of this embodiment of this disclosure, after the three-dimensional location information of the tracked object is obtained, smoothing processing, noise elimination, missing data completion, or the like may be performed at a three-dimensional location of the tracked object in each frame, to improve accuracy of the three-dimensional location information of the tracked object.

206. Add the tracking data for the tracked object based on the three-dimensional location information.

After the tracked object is determined, the tracking data corresponding to the tracked object may be determined. After the three-dimensional location information of the tracked object in the panoramic video data is obtained, the tracking data is added for the tracked object based on the three-dimensional location information.

Specifically, tracking data such as audio data, a subtitle, or mosaic is added at a location of the tracked object in each frame in the panoramic video data. The tracking data may be adjusted based on the three-dimensional location information of the tracked object. For example, if the tracking data is audio data, a direction of the audio data may be set based on plane coordinates of the tracked object, and a volume magnitude value of the audio data may be adjusted based on a depth value of the tracked object. For example, a larger depth value means a longer distance and a smaller volume magnitude value, a smaller depth value means a shorter distance and a larger volume magnitude value.

In this disclosure, after any frame in the panoramic video data is obtained as the first sample frame, the at least one key object may be determined in the first sample frame, and the input data may be obtained. The tracked object in the at least one key object is determined by using the input data, and the tracked object has the corresponding tracking data. Then after the tracked object is determined, the three-dimensional location information of the tracked object is determined in the panoramic video. The three-dimensional location information is information about locations of the tracked object in all frames in the panoramic video data, and the tracking data of the tracked object is added based on the three-dimensional location information, so that a correspondence is established between the tracking data and the three-dimensional location of the tracked object in the panoramic video data. Therefore, in this application, 3D data does not need to be aligned with an object at each key frame. After the at least one key object is identified, a user may determine the tracked object, and then the tracking data may be automatically added to the panoramic video for the tracked object. This improves efficiency for adding the tracking data for the tracked object.

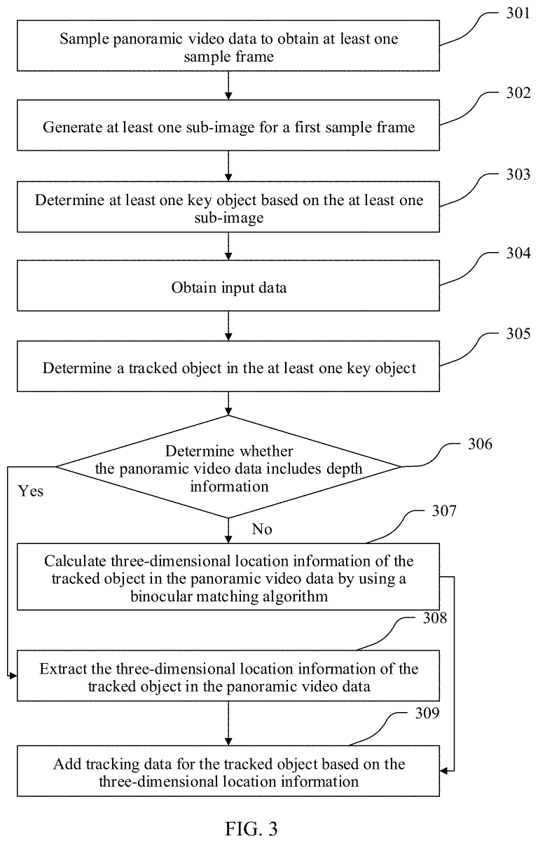

The foregoing describes a procedure of the panoramic video data processing method provided in this disclosure. The following describes the panoramic video data processing method provided in this disclosure in a more detailed manner. FIG. 3 is another schematic flowchart of a panoramic video data processing method according to an embodiment of this disclosure. The method may include the following operations.

301. Sample panoramic video data to obtain at least one sample frame.

After the panoramic video data is obtained, the panoramic video data may be sampled to obtain the at least one sample frame. A specific manner may be determining every N^{th} frame in the panoramic video as a sample frame, where N is a positive integer, and N may be preset value or a value entered by a user; or may be directly determining, by a user, any one or more frames in the panoramic video data as a sample frame.

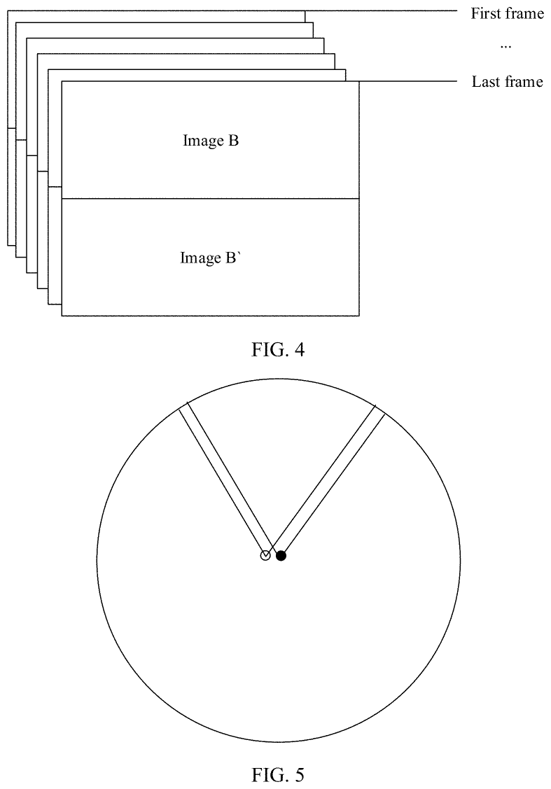

In this embodiment of this disclosure, the panoramic video data may be up-and-down 3D data, left-and-right 3D data, or the like. Therefore, each frame in the panoramic video data may include a left-eye-view image and a right-eye-view image. In addition, the left-eye-view image and the right-eye-view image include same objects. For example, panoramic video data of up-and-down 3D data may be shown in FIG. 4, and may include x frames in total. Every n^{th} frame is determined as a sample frame.

302. Generate at least one sub-image for a first sample frame.

After the at least one sample frame of the panoramic video data is obtained, at least one sub-image corresponding to each sample frame is generated. Using the first sample frame as an example, the at least one sub-image may be generated for the first sample frame. Any one of the at least one sample frame may be determined as the first sample frame, or one of the at least one sample frame may be determined as the first sample frame according to a preset rule, or a sample frame may be randomly determined as the first sample frame, or one of the at least one sample frame may be determined as the first sample frame based on input of the user, or the like.

In addition, after the first sample frame is determined, the first sample frame may include a left-view image and a right-view image, and a sub-image of the left-view image or the right-view image may be further obtained. Specifically, the left-view image and the right-view image may be separately expanded and assigned into two virtual spheres with a same size, to form three-dimensional panoramic images respectively corresponding to a left view and a right view. The three-dimensional panoramic images are omnidirectional three-dimensional images. This is equivalent to restoring three-dimensional scenarios respectively corresponding to the left view and the right view. Usually, the left view and the right view correspond to a same three-dimensional scenario. After the three-dimensional panoramic images respectively corresponding to the left view and the right view are obtained, corresponding sub-images are obtained, including a sub-image corresponding to the left view and a sub-image corresponding to the right view.

It should be noted that, when the at least one sub-image is generated for the first sample frame, the at least one sub-image may be generated by using only the left-view image, or the at least one sub-image may be generated by using only the right-view image, or the at least one sub-image may be generated by using both the left-view image and the right-view image. This may be specifically adjusted based on an actual application scenario, and is not limited in this disclosure.

For example, the first sample frame is an up-and-down 3D image, and is split into a left-view image and a right-view image, the left-view image is restored to a left-view three-dimensional panoramic image, and the right-view image is restored to a right-view three-dimensional panoramic image. Then a left-view sub-image and a right-view sub-image may be respectively captured from the left-view three-dimensional panoramic image and the right-view three-dimensional panoramic image according to a preset rule. The preset rule may be capturing a sub-image from a preset angle, or capturing a plurality of sub-images with a preset size. This may be understood as splitting each of the left-view three-dimensional panoramic image and the right-view three-dimensional panoramic image into a plurality of sub-images. For example, as shown in FIG. 5, the left-view three-dimensional panoramic image and the right-view three-dimensional panoramic image may be understood as overlapping images. A left virtual camera and a right virtual camera may be created. In the following, the two virtual cameras may become a left-eye camera and a right-eye camera to simulate a left eye and a right eye of a viewer. A midpoint of a connection line between the two virtual cameras is a center of a sphere, and a distance of the connection line between the two virtual cameras may be an inter-pupil distance (IPD) of the viewer, or may be an IPD distance used for collecting the panoramic video data. Usually, a panoramic video is obtained by splicing images that are obtained through photographing by a plurality of cameras. Therefore, IPD values of panoramic videos obtained through photographing by different panoramic cameras are different. The left-eye camera may capture left-view data, and the right-eye camera may capture right-view data. In addition, the two virtual cameras may rotate around the center of the sphere to capture a plurality of sub-images. Compared with each frame of image in a panoramic video, panoramic video data during photographing is obtained by splicing a plurality of images that are obtained through photographing by a camera array. An original image obtained through photographing is spherical, but a panoramic video output from the obtained panoramic video data is usually rectangular, thereby causing distortion. However, in this disclosure, the first sample frame in the panoramic video data is restored to a sphere, and the two virtual cameras are used for photographing, so that distortion of the first sample frame can be effectively reduced.

303. Determine at least one key object based on the at least one sub-image.

After the at least one sub-image of the first sample frame is obtained, the at least one sub-image is identified to determine the at least one key object. The key object may include a person, an article, or the like included in the first sample frame, or may include an object of a preset shape, or the like.

If the first sample frame includes the left-view image and the right-view image, when a key object is being determined, the at least one key object may be identified based on either the left-view image or the right-view image, or the at least one key object may be identified based on both the left-view image and the right-view image.

Specifically, an identification algorithm may include an object detection algorithm, a facial detection algorithm such as a facial landmark detection (Dlib landmark detection) algorithm, a neural network identification algorithm, a vector machine identification algorithm, or the like. More specifically, detection may be performed on a distribution feature of pixels in each sub-image, to identify an object in the sub-image, where the object includes a face, a preset article, or the like.

It should be understood that objects included in the first sample frame may be classified into a primary object and a secondary object. The primary object is a key object. The secondary object may be understood as an object not meeting a preset condition in the first sample frame. For example, if a pixel range occupied by an object in the first sample frame is less than a threshold, the object is a secondary object; or if an object is beyond a range of a threshold, the object is a secondary object. Usually, after all objects included in the first sample frame are identified, a key object in all the objects, that is, the at least one key object in this embodiment of this disclosure, may be further determined. Therefore, in this embodiment of this disclosure, all the objects in the first sample frame may be identified, the key object in all the objects is determined, and an irrelevant object is filtered out, thereby improving accuracy for identifying the key object.

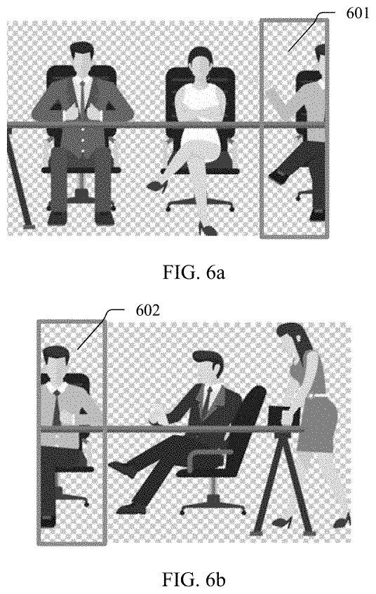

In a possible scenario, when a virtual camera is used to obtain sub-images, edges of some sub-images may overlap. Usually, an overlapping region is related to a horizontal field of view of the virtual camera. A larger horizontal field of view indicates a larger amount of overlapping data and greater image distortion at an edge. A smaller horizontal field of view indicates a smaller overlapping region and a higher possibility of missing identification of an object because the object only partially appears at an edge of a sub-image. Therefore, detection may be further performed on an edge of each sub-image, to detect for a preset range of the edge of each sub-image. If it is identified that feature distributions of objects in a plurality of sub-images meet a preset rule, it can be considered that the plurality of sub-images include a same object. Alternatively, if it is directly identified that a plurality of sub-images include a same feature, it can be considered that the plurality of sub-images include a same object, or the like. For example, as shown in a first sub-image in FIG. 6a and a second sub-image in FIG. 6b, an object marked by a marker box 601 at an edge of the first sub-image and an object included by a marker box 602 at an edge of the second sub-image are the same object. A specific identification manner may be identifying, through feature detection, a first distribution regularity of pixel values of pixels of an object in the first sub-image, and a second distribution regularity of pixel values of pixels of an object in the second sub-image. If the first distribution regularity is highly similar to the second distribution regularity, the objects can be considered as a same object. Alternatively, whether pixel distributions around the marker boxes are the same or overlapping is identified. If the pixel distributions are the same or overlapping, and pixel distributions in the marker boxes are symmetric, partially the same, or identical, it can be considered that the first sub-image and the second sub-image include a same object, that is, the objects in the marker boxes in FIG. 6a and FIG. 6b are a same object. Therefore, in this embodiment of this disclosure, missing identification of some objects due to partial overlapping of sub-images can be avoided, thereby improving accuracy for identifying a key object.

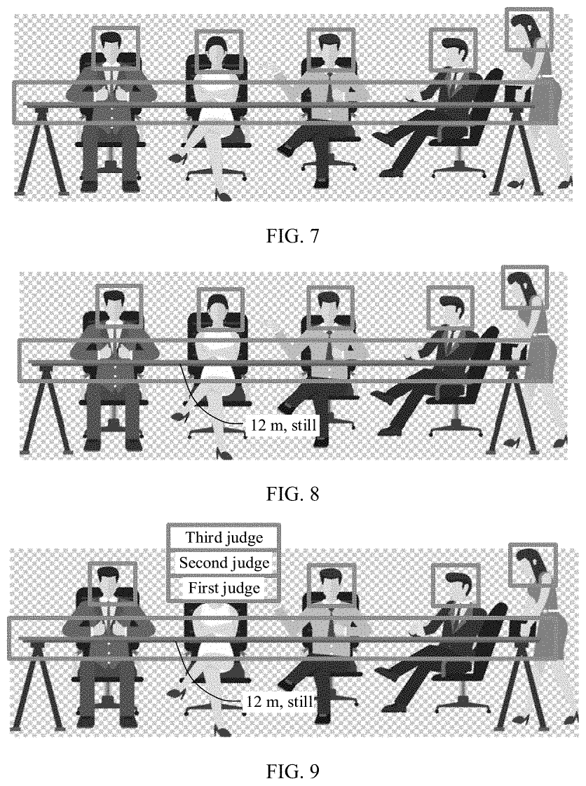

After the at least one key object is determined based on the sub-image, if the first sample frame includes the left-view image and the right-view image, either the left-view image or the right-view image may be displayed, or a composite image obtained by combining the left-view image and the right-view image may be displayed. The left-view image and the right-eye-view image include a same object. In addition, a marker box may be added for each key object, and the marker box includes a corresponding key object. For example, as shown in FIG. 7, the left-view image in the first sample frame may be displayed, and the at least one key object in the first sample frame may be displayed. One marker box may be generated for each object. For example, a marker box is added for an identified face, or a marker box is added for an identified article. Therefore, after the key object is identified, the first sample frame may be displayed, and the key object is highlighted by using the marker box, so that the user can have more direct perception in observing each key object and more accurately determine tracking data corresponding to each key object.

In an optional embodiment of this disclosure, a corresponding marker box is generated based on related information of the key object. For example, for a key object with a smaller size, a smaller marker box is generated; or for a key object with a smaller size, a marker box with higher transparency is generated. Therefore, in this embodiment of this disclosure, an important object may be distinguished from an unimportant object. For an object with a small ratio, a smaller marker box may be displayed, and for an object with a large ratio, a larger marker box may be displayed, to highlight an important object.

In an optional embodiment of this disclosure, in addition to adding a marker box for an identified key object, prompt information may be further generated for all or some key objects, and the prompt information is displayed around the key object in an overlay manner. For example, as shown in FIG. 8, prompt information “12 m, still” may be added for an identified article. In addition, the prompt information may further include a type of the key object. If the identified key object is a musical instrument, the prompt information may include a musical instrument icon. Therefore, in this embodiment of this disclosure, the prompt information related to the key object may be further displayed, so that the user can have more direct perception in observing the key object and more accurately determine the type of the key object, and in turn accurately determine a tracked object in the key object.

304. Obtain input data.

After the at least one key object in the first sample frame is determined, the input data may be obtained. The input data may be obtained by performing input on the at least one key object in the first sample frame.

For example, the first sample frame may be displayed, the at least one key object is marked in the first sample frame, and the user may perform input based on the marked at least one key object, and select one of the at least one key object to obtain the input data. If the first sample frame includes the left-view image and the right-view image, either the left-view image or the right-view image may be displayed. For example, if the left-view image is displayed and the at least one key object is marked in the left-view image in an overlay manner by using a marker box, the user may select any one of the at least one key object to obtain the input data.

Therefore, in this embodiment of this disclosure, after the at least one key object in the first sample frame is determined, the input data may be further obtained. The input data may be obtained by performing input by the user, so that the user may perform selection based on the at least one key object in the first sample frame, to determine a tracked object.

305. Determine a tracked object in the at least one key object.

After the input data is obtained, the tracked object in the at least one key object may be determined based on the input data. In addition, after the tracked object is determined, tracking data corresponding to the tracked object may be further determined based on a type of the tracked object.

For example, if the user selects one of the at least one key object in the first sample frame and performs an input operation to obtain the input data, the input data may include related information of the tracked object, for example, a coordinate location or the type of the tracked object. Therefore, the tracked object may be determined based on the related information of the tracked object that is included in the input data.

For example, as shown in FIG. 9, based on display of the left-view image or the right-view image in the first sample frame, a marker box for marking each key object may be displayed in an overlay manner. The user may select, by using an input device, a type of each marker box, for example, one of “first judge”, “second judge”, or “third judge”. The tracked object and the tracking data corresponding to the tracked object are determined. For example, “first judge” may correspond to audio data of a first judge, “second judge” may correspond to audio data of a second judge, and “third judge” may correspond to audio data of a third judge.

Therefore, in this embodiment of this disclosure, the user needs to only select the tracked object, and the tracked object has the corresponding tracking data. Subsequently, the tracking data may be automatically added for the tracked object, thereby improving efficiency for adding the tracking data to the panoramic video data for the tracked object.

306. Determine whether the panoramic video data includes depth information. If the panoramic video data includes depth information, perform operation 308; or if the panoramic video data does not include depth information, perform operation 307.

After the at least one key object is determined, whether the panoramic video data includes depth information may be determined. If the panoramic video data includes depth information, the depth information may be directly extracted, and a three-dimensional location of the tracked object in each frame is determined, to obtain three-dimensional location information of the tracked object in the panoramic video data. If the panoramic video data does not include depth information, a three-dimensional location of the tracked object in each frame may be calculated based on a binocular matching algorithm, to obtain three-dimensional location information of the tracked object in the panoramic video data.

307. Determine the three-dimensional location information of the tracked object in the panoramic video data by using the binocular matching algorithm.

If the panoramic video data does not include depth information, a depth value of the tracked object in each frame of image in the panoramic video data should be calculated by using the binocular matching algorithm. A location of the tracked object in each frame of image may be represented by using a horizontal coordinate by establishing coordinate axes. After the depth value of the tracked object in each frame of image is calculated, a three-dimensional location of the tracked object in each frame of image may be determined based on the depth value in combination with the horizontal coordinate of the tracked object in each frame, to obtain the three-dimensional location information of the tracked object in the panoramic video data.

Specifically, each frame in the panoramic video data may be up-and-down 3D data, left-and-right 3D data, or the like, and each frame may include a left-view image and a right-view image. After the tracked object is determined, the tracked object in each frame of image in the panoramic video data is identified based on the tracked object in the first sample frame. An offset between the left-view image and the right-view image of the tracked object may be calculated, and the depth value of the tracked object may be calculated based on the offset, and in turn the three-dimensional location information of the tracked object in the panoramic video data may be determined.

For example, a binocular virtual camera may be used to capture the tracked object and images within a range of the tracked object and a surrounding preset range by centering around a spherical center of a restored left-view or right-view three-dimensional panoramic image and pointing at the tracked object. For example, if a width of the range of the tracked object is w, a width of the surrounding preset range may be any range within 20% xw-30% xw, and may include most features of the tracked object, to improve accuracy of subsequent identification. A left-eye virtual camera captures an image, of the tracked object, that corresponds to the left-eye view. A right-eye virtual camera captures an image, of the tracked object, that corresponds to the right-eye view. Then an offset between the left-eye-view image and the right-eye view image of the tracked object is calculated, and a depth value of the tracked object is calculated based on the offset. For example, the depth value may be calculated based on the following formula: depth=(f×baseline)/disp, where f represents a normalized focal length, baseline is a distance between optical centers of the two virtual cameras, and may also be referred to a baseline distance, and disp is a parallax value, namely, the offset. Quantities after the equal sign are all known, and therefore the depth value (depth) may be calculated. After the depth value of the tracked object in each frame of image is calculated, the three-dimensional location of the tracked object in each frame of image may be obtained based on the depth value in combination with plane coordinates of the tracked object in each frame, and in turn the three-dimensional location information of the tracked object in the panoramic video data may be obtained. For example, a three-dimensional location of the tracked object in a frame of image may include a depth value and plane coordinates of the tracked object in this frame of image.

Therefore, in this embodiment of this disclosure, if the panoramic video data does not include depth information, the depth value of the tracked object may be calculated based on the binocular matching algorithm, and in turn the three-dimensional location information of the tracked object in the panoramic video data may be determined, so as to accurately add the tracking data for the tracked object.

In addition, when the offset is calculated, a depth sub-value corresponding to each pixel of the tracked object may be calculated, and then a weighting operation is performed on the depth sub-value corresponding to each pixel to obtain the depth value of the tracked object.

When the tracked object includes a plurality of pixels in a preset range, after a depth value corresponding to each pixel is determined, a weighting operation is performed on the depth value of each pixel. At least one pixel corresponding to a preset feature of the tracked object is determined. A first weight value corresponding to the at least one pixel, and a second weight value corresponding to a pixel other than the at least one pixel of the tracked object are determined, where the first weight value is greater than the second weight value. Then the depth value of the tracked object is calculated based on the first weight value, the second weight value, and the depth value corresponding to each pixel. For example, when an offset of a face is calculated, weights of depth values of pixels for comparatively distinct features such as mouth corners and eye corners, that is, the first weight value, may be increased, and features of remaining parts correspond to the second weight value, so that the calculated depth value of the tracked object is more accurate.

308. Extract the three-dimensional location information of the tracked object in the panoramic video data.

If the panoramic video data includes depth information, the depth value of the tracked object in each frame may be directly extracted from the panoramic video data, and the three-dimensional location information of the tracked object in the panoramic video data may be obtained based on the depth value in combination with the plane coordinates of the tracked object in each frame of image. Specifically, after the tracked object is determined based on the input data, each frame of image may be identified, and a location of the tracked object in each frame of image may be determined, to obtain the plane coordinates of the tracked object in each frame of image.

Specifically, the depth information may be a segment of data in the panoramic video data, and each pixel of each frame has a corresponding depth value. After the tracked object is determined in the first sample frame, the location of the tracked object in each frame of image in the panoramic video data is identified. Then the depth value of the tracked object in each frame of image is extracted, based on the location of the tracked object in each frame image, from the depth information included in the panoramic video data. Further, the three-dimensional location information of the tracked object in the panoramic video data is determined based on the depth value in combination with coordinates of the tracked object in each frame of image.

In addition, the depth information in the panoramic video data may be further included in the depth value of each frame of image. There is a correspondence between a grayscale value and a depth value. A depth value may be converted into a grayscale value based on a preset correspondence, and the grayscale value is stored in a pixel in each frame of image. After the location of the tracked object in each frame of image is determined, a grayscale value at the location of the tracked object in each frame of image may be extracted, and the grayscale value is converted into a depth value based on the preset correspondence. After the depth value of the tracked object in each frame of image is obtained, three-dimensional coordinates of the tracked object in each frame of image may be determined based on the depth value in combination with information about the location of the tracked object in each frame of image, and in turn the three-dimensional location information of the tracked object in the panoramic video data may be determined.

309. Add the tracking data for the tracked object based on the three-dimensional location information.

After the three-dimensional location information of the tracked object in the panoramic video data is determined, the tracking data may be added for the tracked object.

Specifically, the three-dimensional location information may include a three-dimensional location of the tracked object in each frame in the panoramic video data, and the tracking data may be added for the tracked object based on the three-dimensional location of the tracked object in each frame of image. The tracking data is, for example, audio data, a subtitle, a special effect, mosaic, and other data corresponding to the tracked object.

More specifically, a location, a magnitude, a direction, and the like of the tracked object may be determined based on the three-dimensional location information of the tracked object. The tracking data is added for the tracked object in each frame of image based on the three-dimensional location of the tracked object in each frame of image.

In addition, in this embodiment of this disclosure, the tracking data may be added for each frame after a three-dimensional location of the tracked object in any frame is obtained, or the tracking data may be added after three-dimensional locations of the tracked object in all frames are obtained. This may be specifically adjusted based on an actual application scenario, and is not limited in this disclosure.

In an optional embodiment of this application, when the tracking data is added for the tracked object based on the three-dimensional location information, a display progress bar may be further added, to mark a progress of adding the tracking data for the tracked object, so that the user can have more direct perception in observing the progress of adding the tracking data.

Usually, if it is determined that an object has a small location change in the panoramic video data, the object may be classified as a still article. When an article is determined as a still article, a location of only one frame or X frames of the article should be calculated. X is a positive integer, and may be a preset value, or may be determined through input by the user. A three-dimensional location of the still article in each frame does not need to be calculated, to eliminate a jitter caused by an algorithm error and reduce a calculation amount.

In an optional embodiment of this embodiment of this application, after the three-dimensional location information of the tracked object is obtained, smoothing processing, noise elimination, missing data completion, or the like may be performed at the three-dimensional location of the tracked object in each frame, to improve accuracy of the three-dimensional location information of the tracked object. Specifically, if there is a comparatively large difference between a three-dimensional location of a frame and that of an adjacent frame, the location of the frame may be processed, so that the three-dimensional location of the frame is close to that of the adjacent frame. If a frame does not include a three-dimensional location of the tracked object but an adjacent frame includes a three-dimensional location of the tracked object, the three-dimensional location of the adjacent frame may be used as a three-dimensional location of the frame.

In a possible scenario, the tracked object may include a plurality of pixels, and a depth value of each pixel may vary. Therefore, when the depth value of the tracked object in each frame of image is being determined, a depth value of a pixel in a center of the tracked object or a specified pixel may be directly extracted as the depth value of the tracked object; or after a depth value of the tracked object at a pixel in each frame of image is extracted, a weighting operation may be performed to obtain a weighted depth value as the depth value of the tracked object; or the like. Therefore, in this embodiment of this application, the depth value of the tracked object can be determined more accurately, to improve accuracy of the obtained three-dimensional location of the tracked object and more accurately add the tracking data for the tracked object.

In this embodiment of this disclosure, the panoramic video data may be sampled to obtain a plurality of sample frames, and at least one key object is determined in each of the plurality of sample frames. In this embodiment of this disclosure, using the first sample frame as an example, a plurality of sub-images may be generated based on the first sample frame, and the at least one key object included in the first sample frame is identified based on the plurality of sub-images. Then the tracked object in the at least one key object is determined based on the input data. The three-dimensional location of the tracked object in each frame in the panoramic video data is determined, and the tracking data is added based on the three-dimensional location of the tracked object in each frame in the panoramic video data, so that a correspondence is established between the tracking data and the three-dimensional location of the tracked object in the panoramic video data. Therefore, in this application, 3D data does not need to be aligned with an object at each key frame. After the at least one key object is identified, a user may determine the tracked object, and then the tracking data may be automatically added to the panoramic video for the tracked object. This improves efficiency for adding the tracking data for the tracked object. In addition, in this disclosure, the tracking data may be added based on the depth information of the tracked object, and the user does not need to estimate depth information or add tracking data, so that accuracy for adding the tracking data can be improved, and user experience can be improved.

The foregoing describes in detail the process of the panoramic video data processing method provided in this embodiment of this disclosure. The following describes an example of the process of the panoramic video data processing method provided in this disclosure by using a specific scenario of adding audio data for panoramic video data.

The panoramic video data processing method provided in this disclosure may be carried on a terminal such as a computer or a tablet computer. The panoramic video processing method provided in this disclosure is usually performed in a form of an application program. The method may also be referred to as a software program, editing software, or the like in the following.

First, panoramic video data may be obtained. The panoramic video data may be imported from a server by using a local storage medium or a network. The panoramic video data may be left-and-right 3D data or up-and-down 3D data. Specifically, when the panoramic video data is obtained, a user may manually choose whether the panoramic video data is left-and-right 3D data or up-and-down 3D data, or the obtained panoramic video data may be identified. Specifically, one or more frames in the panoramic video data may be selected, the one or more frames of images may be divided into halves, including division into upper and lower halves or division into left and right halves. Then identification is performed. If it is identified that the upper and lower halves of the one or more frames are similar, this may be understood as that the panoramic video data is up-and-down 3D data. If it is identified that the left and right halves of the one or more frames are similar, this may be understood as that the panoramic video data is left-and-right 3D data. In addition, a data format of the panoramic video data may be directly identified to determine a data type of the panoramic video data. For example, the data type of the panoramic video data may be determined by using a file name extension, a file attribute, or the like of the panoramic video data.

After the panoramic video data and the corresponding data type are obtained, the panoramic video data is sampled, and every N^{th} frame is determined as a sample frame, to obtain at least one sample frame. Then a key object included in the panoramic video data is determined based on each of the at least one sample frame. All sample frames may be identified to determine the key object in the panoramic video data. Specifically, each sample frame may be split into a left-view image and a right-view image. Then the left-view image and the right-view image corresponding to each sample frame are expanded into a left-view three-dimensional panoramic image and a right-view three-dimensional panoramic image respectively. Usually, the expanding is to assign, as stickers, the left-view image and the right-view image into two spheres with a same size. Then the key object in the panoramic video data is identified based on the left-view three-dimensional panoramic image and the right-view three-dimensional panoramic image that correspond to each sample frame.

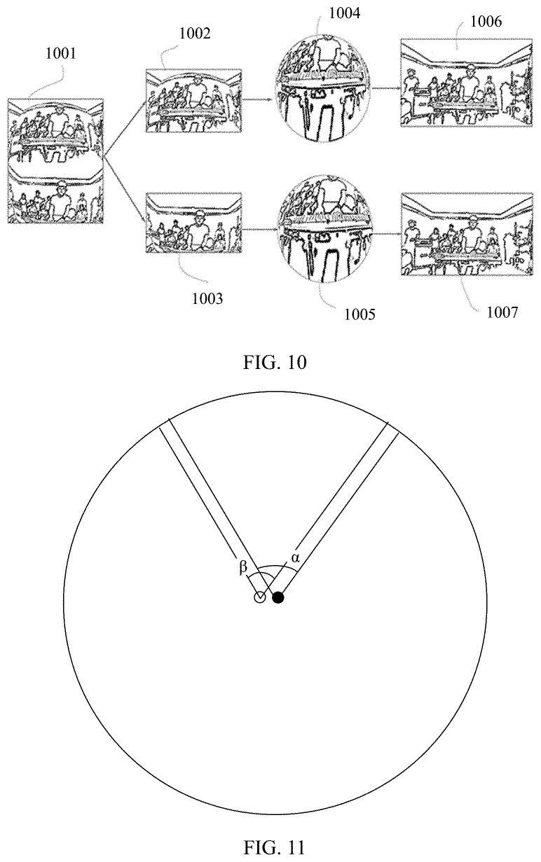

Using a first sample frame in the at least one sample frame as an example, the first sample frame may be displayed on a display screen, and the first sample frame may be divided into a left-view image and a right-view image. For example, as shown in FIG. 10, using a first sample frame 1001 as an example, the first sample frame 1001 may be divided into a left-view image 1002 and a right-view image 1003. The left-view image 1002 and the right-view image 1003 are assigned into two same spheres to obtain a left-view three-dimensional panoramic image 1004 and a right-view three-dimensional panoramic image 1005. The left-view three-dimensional panoramic image 1004 and the right-view three-dimensional panoramic image 1005 include same objects. After the left-view three-dimensional panoramic image 1004 and the right-view three-dimensional panoramic image 1005 are obtained, a sub-image in the left-view three-dimensional panoramic image is captured from the left-view three-dimensional panoramic image 1004 by using a left-view virtual camera based on a preset angle, to obtain a left-view sub-image 1006. A sub-image in the right-view three-dimensional panoramic image is captured from the right-view three-dimensional panoramic image 1005 by using a right-view virtual camera based on a preset angle, to obtain a right-view sub-image 1007.

Usually, each frame in the panoramic video data is a processed rectangular image, and distortion easily occurs due to a convex lens of a camera, a distance from an object, or other reasons. In this embodiment of this disclosure, the left-view image and the right-view image in the first sample frame are restored to three-dimensional panoramic images of spheres, and then sub-images are captured by using a binocular virtual camera. Compared with directly using the left-view image and the right-view image in the first sample frame, this can reduce object distortion and improve accuracy for subsequently identifying a key object.

Specifically, a schematic diagram of a photographing plane of a binocular virtual camera is shown in FIG. 11. A left-view three-dimensional panoramic image and a right-view three-dimensional panoramic image include same content. Therefore, a left-view three-dimensional panoramic image and a right-view three-dimensional panoramic image of a sphere may basically coincide. 13 is a left-view horizontal field of view, that is, an angle range for a left-view virtual camera to capture a sub-image. a is a right-view horizontal field of view, that is, an angle range for a right-view virtual camera to capture a sub-image. Usually, in this embodiment of this disclosure, a left-view or right-view horizontal field may range from 90° to 107°, so that adjacent low-distortion sub-images generated by the cameras have a comparatively large overlapping region. This avoids missing identification of an object in the overlapping region and also avoids excessive distortion of sub-images.

After at least one sub-image of the left-view image and the right-view image in the first sample frame is captured, at least one key object in the first sample frame is identified based on the at least one sub-image. Identification may be performed based on at least one sub-image of the left-view image, or identification may be performed based on at least one sub-image of the right-view image, or identification may be performed based on both at least one sub-image of the left-view image and at least one sub-image of the right-view image, to determine the at least one key object in the first sample frame.

After the at least one sub-image including the at least one sub-image corresponding to the left-view image or the at least one sub-image corresponding to the right-view image is determined, a key object in each sub-image is identified based on the at least one sub-image. Usually, a key object in a video to which a three-dimensional audio source is added is usually a face, a limb, any type of musical instrument, or the like. Therefore, the face, the limb, the any type of musical instrument, or the like should be identified by an object identification algorithm. A plurality of different object identification algorithms may be run for one sub-image, to ensure that all articles can be identified. The object identification algorithm may include a facial detection algorithm, an object detection algorithm, or the like, and can identify a face, a limb, a musical instrument, or the like in the first sample frame.

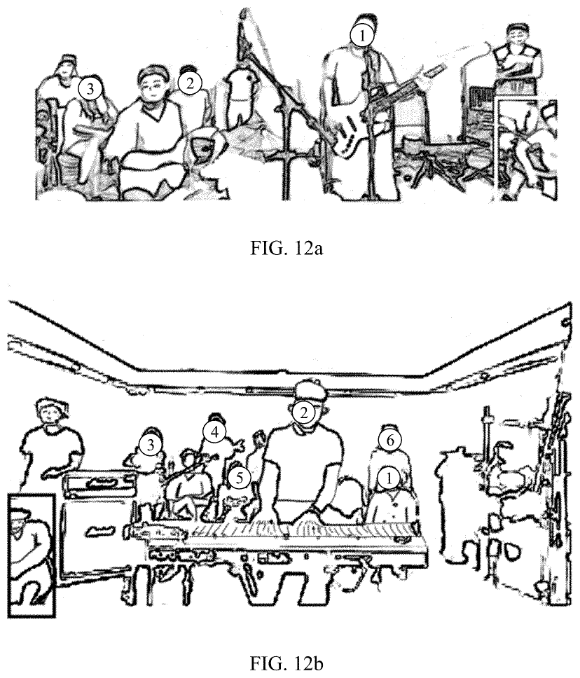

In a possible scenario, when the binocular virtual camera captures sub-images, a plurality of generated sub-images have an overlapping region, and the overlapping region is related to a horizontal field of view of the virtual camera. A larger horizontal field of view indicates a larger overlapping region but also a larger amount of data that should be processed and greater image distortion at an edge. A smaller horizontal field of view indicates a smaller overlapping region and a higher possibility of missing identification of an object because the object only partially appears at an edge of a field of view. For example, as shown in FIG. 12a and FIG. 12b, when sub-images are captures, an audience A appears in both a first sub-image and a second sub-image, and both the first sub-image and the second sub-image include only a partial feature of the audience A. Therefore, missing identification easily occurs when the sub-images are separately identified. In this embodiment of this disclosure, an edge may be identified by using a preset identification algorithm. Specifically, a first distribution regularity of pixel values of pixels of an object in the first sub-image, and a second distribution regularity of pixel values of pixels of an object in the second sub-image may be identified through feature detection. If the first distribution regularity is highly similar to the second distribution regularity, the objects can be considered as a same object. Alternatively, whether pixel distributions around marker boxes are the same or overlapping is identified. If the pixel distributions are the same or overlapping, and pixel distributions in the marker boxes are symmetric, partially the same, or identical, it can be considered that the first sub-image and the second sub-image include a same object, that is, objects in the marker boxes in FIG. 12a and those in FIG. 12b are the same objects.

In addition, when the face, the limb, the musical instrument, or the like in the first sample frame is identified, deduplication may be further performed to remove duplicate identified objects, to avoid duplication of an identified key object. Specifically, identified pixel value distribution features of objects may be compared. If pixel value distributions are identical and ranges, locations, and the like occupied by pixel values are the same, the objects are considered as a same object.

After objects in the first sample frame are identified, the objects may be screened based on features of the objects. The objects may be classified into a primary object, namely, a key object, and a secondary object. No tracking data needs to be added for the secondary object. Therefore, the secondary object does not need to be recorded. For example, when a scenario includes many identifiable articles, for example, in a concert scenario, many audiences are identified. However, an object to which an audio source should be added is usually a band member, and no audio source needs to be added to an audience.

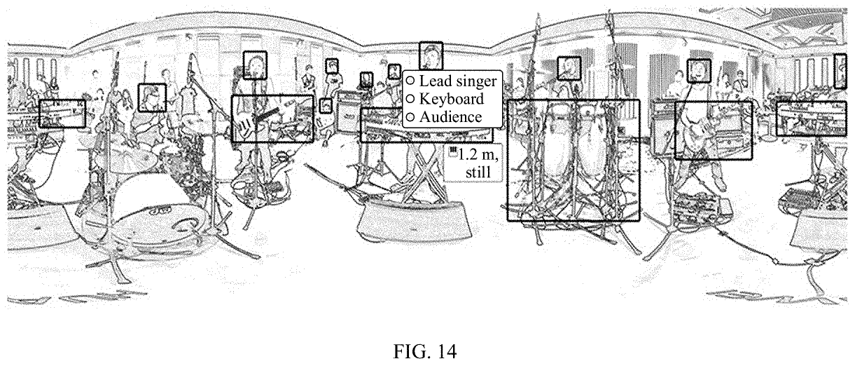

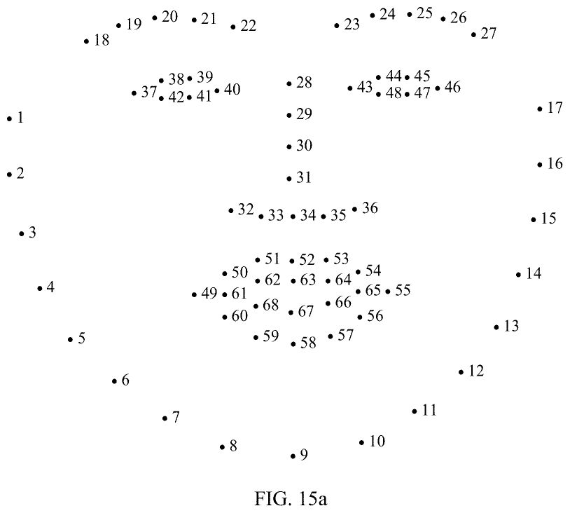

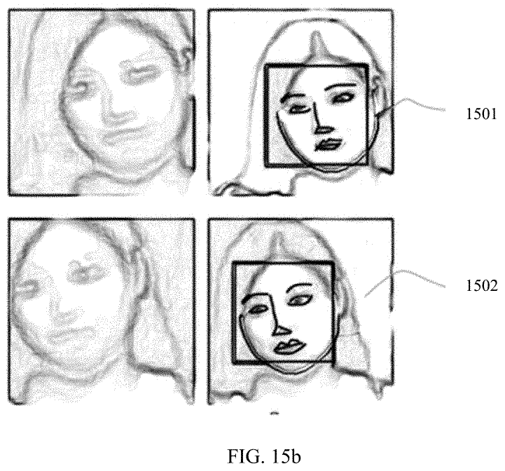

For example, to facilitate selection by the user, a primary object (a band member) may be distinguished from a secondary object (an audience). In addition, an object may be marked by using a marker box, as shown in FIG. 14.

A priority of a secondary object is reduced, and the secondary object is displayed in a color with a higher transparency. For example, a line of an information display box for a band member in FIG. 14 is bolder and has a lower transparency, and a line of an information display box for an audience in the background is thinner and has a higher transparency. In this scenario, the band member is highlighted during display, thereby facilitating selection by the user. Alternatively, a marker box may be added only to a primary object, but no marker box is displayed on a secondary object. Alternatively, different selection sensitivities may be set for a primary object and a secondary object. For example, the primary object is more easily selected, and the secondary object is less easily selected. An embodiment may be as follows: For the primary object, the object can be selected when a focus (for example, a mouse cursor) is farther away (for example, 10 pixels away) from an information display box. For the secondary object, the object can be selected when the focus is closer (for example, 5 pixels away) to the information display box.

Specifically, a manner of determining a primary or secondary object may be indirectly determining a distance from the object to a stage based on an area of a face. A smaller face indicates a longer distance from the object to the stage, and the object may be an audience, and is a secondary object. A larger face indicates a shorter distance from the object to the stage, and the object may be a primary object.

A manner of determining a primary or secondary object may be alternatively determining a band member or an audience based on a motion feature. Generally, a mouth and hands of a band member have a comparatively large movement during a show, and a movement a mouth and hands of an audience is much smaller. Therefore, a band member or an audience may be determined based on a change magnitude of a mouth feature point. If a change magnitude of a mouth feature point of a person is large, it is speculated that the person is singing, and the person is considered as a band member; or if a change magnitude of a mouth feature point of a person is small, the person is considered as an audience. Alternatively, determining may be performed based on whether a mouth is open or closed. A person whose mouth keeps open is more likely to be a band member, and a mouth of an audience is more likely to be closed. For determining whether a mouth is open or closed, a large quantity of marked sample mouth-open pictures and mouth-closed pictures may be first used for training through machine learning, and a classifier obtained through training is used to identify a picture, and in turn determine whether a mouth is open or closed. Alternatively, determining may be performed based on a moving track of a hand. After a hand in an image is determined through image identification, whether the hand of a person has a comparatively large movement is determined based on a moving track of the hand. If the hand has a comparatively large movement, the person is considered as a band member; or if a movement of the hand is not large, the person is considered as an audience.

Certainly, the foregoing manners of determining a primary or secondary object are merely examples for description, and there may also be another manner. This is not limited in this disclosure.

In addition, the foregoing manners of determining a primary or secondary object may be combined for use. For example, the method for performing determining based on a distance and the method based on a motion feature change are used, and different weights are assigned to calculate a synthetic probability of an object being a band member or an audience. For example, a shorter distance corresponds to a larger weight value, and a longer distance corresponds to a smaller weight value. Further, methods based on different motion feature changes may also be combined for use. For example, different weights are assigned to a change of a mouth feature point and a movement of a hand, to calculate a synthetic probability of a motion feature change, and so on.

In addition, after a key object is identified, related information of the key object may be further generated, including information such as a status, a type, and a distance of the key object. For example, information about a keyboard may be displayed in FIG. 14, including a musical instrument icon, a distance of 12 m, a status of being still, and the like. Therefore, the user can more clearly determine a type of the key object, and more accurately select a tracked object.

After key objects in all sample frames are identified, matching may be performed between identification results of the key objects in the sample frames, to determine all objects in the panoramic video data. Optionally, an identification (ID) may be further allocated to each object, to distinguish between objects.

After all key objects are determined, one sample frame may be displayed. A sample frame including the most key objects may be displayed, or a sample frame may be randomly displayed, or the user may select a sample frame to be displayed, or the like. The following describes an example in which the first sample frame is displayed.

A marker box for each key object may be displayed in the first sample frame in an overlay manner. After the user clicks a marker box, a floating window is displayed, and the user selects a parameter corresponding to the clicked key object. The parameter may be used to determine data corresponding to the key object. As shown in FIG. 14, the user may select an audio file corresponding to the object. For example, “lead singer”, “audience”, and “keyboard” may be additionally displayed in the floating window, and have corresponding audio files. For example, “lead singer” may correspond to audio data of a lead singer, “audience” may correspond to audio data of an audience, and “keyboard” may correspond to audio data of a keyboard. In addition, the user may also directly drag an audio file to a corresponding key object, so that a correspondence is established between the audio file and the key object. After a key object selected by the user is determined, the key object is treated as a tracked object, and tracking data of the tracked object is determined.

If the panoramic video data includes depth information, after the user selects a tracked object in the first sample frame, plane coordinates of the tracked object in each frame in the panoramic video data are determined. Then a depth value of the tracked object in each frame is extracted based on the plane coordinates of the tracked object in each frame in the panoramic video data. A three-dimensional location of the tracked object in each frame is determined based on the depth value in combination with the plane coordinates of the tracked object in each frame in the panoramic video data, to obtain three-dimensional location information of the tracked object in the panoramic video data.

Specifically, a manner of extracting the depth value of the tracked object in each frame based on the plane coordinates of the tracked object in each frame in the panoramic video data may be directly obtaining the depth value based on the plane coordinates of the tracked object in each frame in the panoramic video data and a preset mapping relationship, or may be determining the depth value based on a grayscale value of the tracked object in each frame in the panoramic video data and a corresponding mapping relationship. If the depth value is directly obtained based on the plane coordinates of the tracked object in each frame in the panoramic video data and the preset mapping relationship, a specific manner may be: after the plane coordinates of the tracked object in each frame in the panoramic video data are determined, directly extracting the depth value of the tracked object in each frame in the panoramic video data from stored data based on the plane coordinates of the tracked object in each frame in the panoramic video data. If the depth value is determined based on the grayscale value of the tracked object in each frame in the panoramic video data and the corresponding mapping relationship, a specific manner may be as follows: Usually, there is a preset correspondence between a grayscale value and a depth value of each pixel in the first sample frame. After a grayscale value of each pixel of the tracked object is determined, a depth value corresponding to each pixel may be calculated based on the preset correspondence. The preset correspondence may be a linear relationship, an exponential relationship, or the like. This may be specifically adjusted based on an actual application scenario, and is not limited herein.

If the panoramic video data does not include depth information, an offset between a left view and a right view of the tracked object may be calculated by using a binocular matching algorithm, and then a depth value corresponding to the tracked object is calculated based on the offset.

Specifically, a binocular virtual camera may be used to capture the tracked object and images within a range of the tracked object and a surrounding preset range by centering around a spherical center of the left-view three-dimensional panoramic image 1004 and the right-view three-dimensional panoramic image 1005 that are restored in FIG. 10 and pointing at the tracked object. For example, if a width of the range of the tracked object is w, a width of the surrounding preset range may be any range within 20%×w-30%×w, to include most features of the tracked object. A left-eye virtual camera captures an image, of the tracked object, that corresponds to a left-eye view. A right-eye virtual camera captures an image, of the tracked object, that corresponds to a right-eye view. Then the offset between the left view and the right view of the tracked object is calculated.

Further, the first sample frame may include an article with an inherent feature, for example, a face; or may include an article without an inherent feature, for example, a musical instrument or a vehicle. Identification algorithms for an article with an inherent feature and an article without an inherent feature may be different. For the first sample frame, a plurality of different identification algorithms may be run simultaneously, to increase a probability of identifying a key object included in the first sample frame.

For an object with an inherent feature, the inherent feature may be identified, and then an offset between a left view and a right view of the object is determined. For example, a manner of calculating an offset in facial recognition may be as follows: An identified object has an inherent feature, for example, a facial organ, an eye, a nose, or another feature. An object-specific feature point identification algorithm, such as a facial feature identification algorithm, is run for captured data. Then a weighted average value of offsets of feature points is calculated. Several comparatively distinct feature points, such as eye corners and mouth corners, have comparatively high weights. For example, FIG. 15a shows 68 feature points that can be identified by the facial feature identification algorithm, and FIG. 15b shows a face image captured by a binocular camera and a result obtained through facial recognition. Sizes of marker boxes for a face 1501 in a left-eye-view image and a face 1502 in a right-eye-view image are different. Therefore, there is a comparatively large error if coordinate midpoints of the marker boxes are directly used as a reference to calculate an offset. Features of mouth corners and eye corners in the 68 features points are subject to comparatively small impact of light and shadow. In addition, a feature at an edge is more distinct, and usually has comparatively high accuracy, and therefore has a comparatively high weight when a weighted average value of offsets are calculated. This is particularly obvious when a face is blurred. Therefore, a face may be identified by using a facial feature point identification method, so that accuracy of facial recognition can be improved. In addition, a location of an identified facial feature is used as a reference to calculate an offset between a left-eye view and a right-eye view of a tracked object, so that accuracy of calculating the offset can be improved.

For an object without an inherent feature, for example, an article such as a vehicle, a musical instrument, or a microphone, a universal feature point identification and matching algorithm may be allowed, for example, vehicle edge detection, detection for a region with a contrast greater than a preset value, or feature identification (feature matching). Usually, a tracked object may include a plurality of feature points, and an offset of the tracked object may be determined through weighted calculation. Usually, if a difference between an offset of a feature point and those of remaining feature points is greater than a threshold, the offset of the feature point has a comparatively low weight.

Therefore, the sample frame in the panoramic video data may include a plurality of types of articles, may include an article with an inherent feature, and may also include an article without an inherent feature. Therefore, the articles included in the sample frame may be accurately identified by combining a facial recognition algorithm and another article identification algorithm, to improve identification accuracy, avoid missing identification or identification errors, and the like.

After the offset is calculated, the depth value of the tracked object may be calculated based on a preset formula. A specific formula may be a linear formula, an exponential formula, or the like, and may be adjusted based on an actual application scenario. For example, the depth value may be calculated based on the following formula: depth=(f×baseline)/disp, where f represents a normalized focal length of the binocular virtual camera, baseline is a distance between optical centers of the two virtual cameras, and may also be referred to a baseline distance, and disp is a parallax value, namely, the offset. f, baseline, and disp are all known, and therefore the depth value (depth) may be calculated. It should be noted that the tracked object may usually occupy a plurality of pixels in the sample frame. When the depth value of the tracked object is calculated, depth values of the plurality of pixels may be calculated. In this case, a depth value of a center pixel may be used as the depth value of the tracked object; or a weighted operation may be performed, and a weighted operation value is determined as the depth value of the tracked object; or a depth value of a preset pixel is used as the depth value of the tracked object; or the like. This may be specifically adjusted based on an actual application scenario, and is not limited in this disclosure.

After the depth value of the tracked object in each frame of image is calculated, the three-dimensional location of the tracked object in each frame of image may be obtained based on the depth value in combination with plane coordinates of the tracked object in each frame, and in turn the three-dimensional location information of the tracked object in the panoramic video data may be obtained. A three-dimensional location of the tracked object in a frame of image may include a depth value and plane coordinates of the tracked object in this frame of image. The plane coordinates may be directly determined based on preset coordinate axes.

After the three-dimensional location of the tracked object in each frame is determined, tracking data is added for the tracked object based on the three-dimensional location of the tracked object in each frame. For example, if the tracked object is a lead singer, audio data corresponding to the lead singer may be added for the tracked object in each frame of image; or if the tracked object is a keyboard, audio data corresponding to the keyboard may be added for the tracked object in each frame of image.

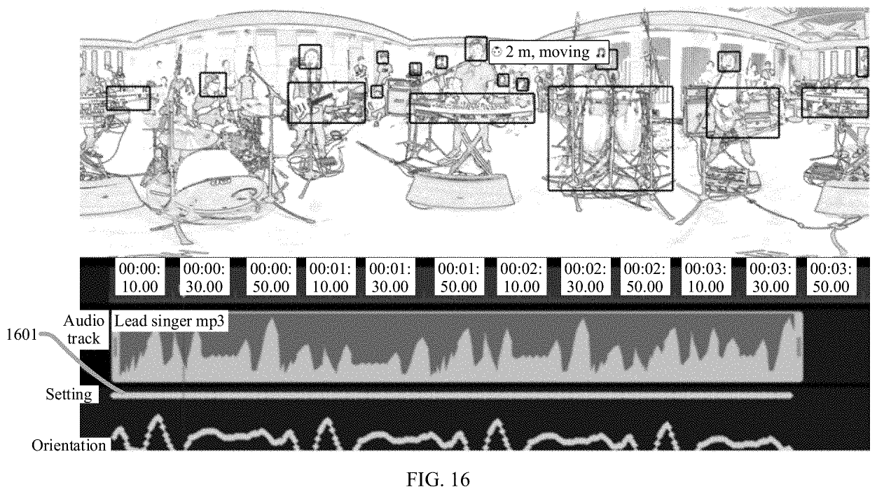

In addition, when the tracking data is added for the tracked object, a progress bar may be added. As shown in FIG. 16, a progress bar 1601 may be used to mark a progress of adding the tracking data for the tracked object. Therefore, a user can have more direct perception in observing a status of adding the tracking data for the tracked object.

In addition, a three-dimensional moving track of the tracked object may be further stored. After tracking for the tracked object is completed, a key frame in the panoramic video data is determined. Each key frame includes information about a three-dimensional location of the tracked object in the key frame, and the three-dimensional location in each key frame may be edited independently. Therefore, the user may adjust a three-dimensional location of the tracking data, thereby improving user experience.

Therefore, in this embodiment of this disclosure, the key object included in the sample frame is first identified, and then the tracked object and the tracking data corresponding to the tracked object are determined based on the input data. The three-dimensional location of the tracked object in each frame in the panoramic video data is determined, and the tracking data is added based on the three-dimensional location of the tracked object in each frame in the panoramic video data. After the tracked object is determined, the tracking data may be automatically added for the tracked object, without manual alignment, thereby reducing a workload of adding the tracking data to the panoramic video data. In addition, identification may be performed by combining different identification algorithms, to identify the tracked object in each frame. This can more accurately track the tracked object in each frame, and improve accuracy for identifying the tracked object. In addition, the key object is identified by capturing sub-images. Compared with directly identifying the key object in a panoramic image in the panoramic video data, this reduces distortion of sub-images, thereby improving accuracy for identifying the key object, and reducing distortion of the identified key object. In addition, after the key object is identified in the sample frame and the tracked object is determined based on the input data, only the tracked object should be identified in each frame. This can reduce a calculation amount of identifying all objects in each frame, and reduce interference from irrelevant data.

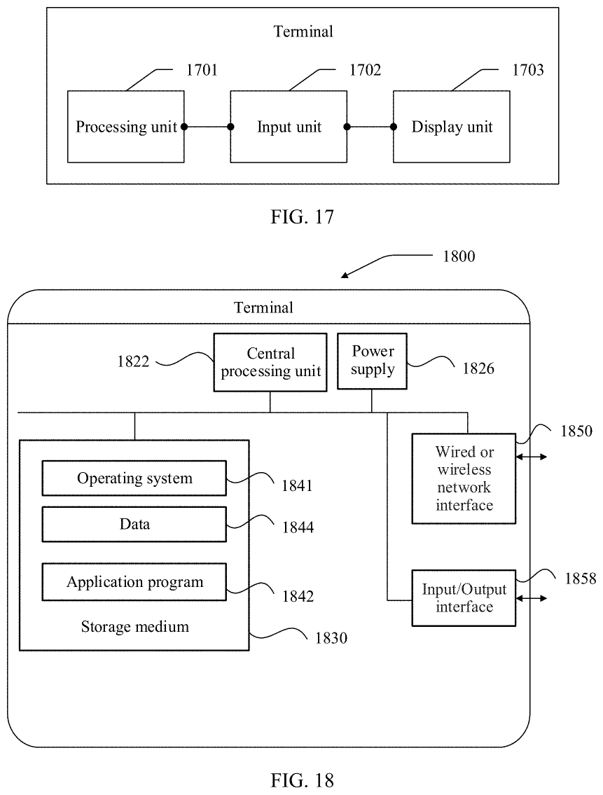

The foregoing describes in detail the method provided in this embodiment of this disclosure. The following describes an apparatus provided in this disclosure. First, the operations of the panoramic video data processing method provided in this disclosure may be performed by a terminal. The terminal may be a mobile phone, a tablet computer, a notebook computer, a television, an intelligent wearable device, another electronic device with a display screen, or the like. The following describes in detail a terminal provided in this disclosure. FIG. 17 is a schematic structural diagram of a terminal according to this disclosure. The terminal may include:

a processing unit 1701, configured to obtain a first sample frame in panoramic video data, where the processing unit 1701 is further configured to determine at least one key object in the first sample frame; and an input unit 1702, configured to obtain input data, where the processing unit 1701 is further configured to determine a tracked object in the at least one key object based on the input data, where the tracked object corresponds to tracking data;

the processing unit 1701 is further configured to obtain three-dimensional location information of the tracked object in the panoramic video data; and

the processing unit 1701 is further configured to add the tracking data for the tracked object based on the three-dimensional location information.

In an optional embodiment, the processing unit 1701 is specifically configured to:

determine coordinates of the tracked object in the panoramic video data; determine a depth value of the tracked object based on the coordinates of the tracked object in the panoramic video data; and determine the three-dimensional location information of the tracked object in the panoramic video data based on depth information and the coordinates of the tracked object in the panoramic video data.

In an optional embodiment, the processing unit 1701 is specifically configured to:

extract the depth information based on a pixel value in the panoramic video data; and

determine the depth value of the tracked object based on the depth information.

In an optional embodiment, the processing unit 1701 is specifically configured to:

determine an offset between a left-eye-view image of the tracked object in the panoramic video data and a right-eye-view image of the tracked object in the panoramic video data; and calculate the depth value of the tracked object based on the offset.

In an optional embodiment, the processing unit 1701 is specifically configured to:

determine an offset corresponding to each pixel of the tracked object in the left-eye-view image in the panoramic video data and the right-eye-view image in the panoramic video data;

and the calculating the depth value of the tracked object based on the offset includes: calculating each depth sub-value corresponding to each pixel based on the offset corresponding to each pixel; and performing a weighting operation on each depth sub-value to obtain the depth value of the tracked object.

In an optional embodiment, the processing unit 1701 is specifically configured to:

determine at least one pixel corresponding to a preset feature of the tracked object; determine a first weight value corresponding to the at least one pixel, and a second weight value corresponding to a pixel other than the at least one pixel of the tracked object, where the first weight value is greater than the second weight value; and calculate the depth value of the tracked object based on the first weight value, the second weight value, and the depth sub-value.

In an optional embodiment, the processing unit 1701 is specifically configured to:

generate at least one sub-image corresponding to the first sample frame; and identify objects in each of the at least one sub-image to obtain the at least one key object corresponding to the first sample frame.

In an optional embodiment, the processing unit 1701 is specifically configured to:

generate a left-view three-dimensional panoramic image based on a left-eye-view image in the first sample frame, and generate a right-view three-dimensional panoramic image based on a right-eye-view image in the first sample frame; and capture a sub-image from the left-view three-dimensional panoramic image or the right-view three-dimensional panoramic image according to a preset rule, to obtain the at least one sub-image.

In an optional embodiment, the processing unit 1701 is specifically configured to:

identify the objects included in each of the at least one sub-image; and determine, based on a preset condition, the at least one key object in the objects included in each sub-image.

In an optional embodiment, before the processing unit 1701 generates the at least one sub-image corresponding to the first sample frame, the processing unit 1701 is further configured to:

determine every N^{th} frame in the panoramic video as a sample frame, to obtain at least one sample frame, where N is a positive integer, and the first sample frame is any one of the at least one sample frame.

In an optional embodiment, the terminal further includes a display unit 1703.

The processing unit 1701 is further configured to generate prompt information for a first key object, where the first key object is prompt information for any one of the at least one key object.

The display unit 1703 is configured to display the prompt information.

FIG. 18 is a schematic structural diagram of a terminal according to an embodiment of this disclosure. The terminal 1800 may vary greatly due to different configurations or performance, and may include one or more central processing units (CPUs) 1822 (or another type of processor) and a storage medium 1830. The storage medium 1830 is configured to store one or more application programs 1842 or data 1844. The storage medium 1830 may be a transient storage or a persistent storage. A program stored in the storage medium 1830 may include one or more modules (not shown in the figure), and each module may include a series of instruction operations for the terminal. Further, the central processing unit 1822 may be configured to communicate with the storage medium 1830, and perform, on the terminal 1800, a series of instructions operations in the storage medium 1830.

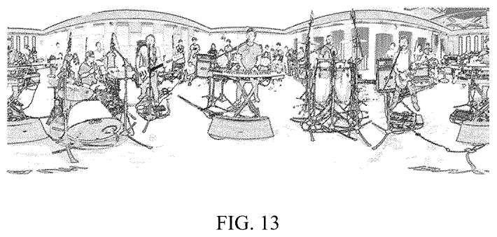

The central processing unit 1822 may perform, according to an instruction operation, any embodiment corresponding to FIG. 2 to FIG. 16.

The terminal 1800 may further include one or more power supplies 1826, one or more wired or wireless network interfaces 1850, one or more input/output interfaces 1858, and/or one or more operating systems 1841, for example, Windows Server™, Mac OS X™, Unix™, Linux™, or FreeBSD™.

The operations performed by the terminal in FIG. 2 to FIG. 16 in the foregoing embodiments may be based on the terminal structure shown in FIG. 18.

More specifically, the terminal provided in this disclosure may be a mobile phone, a tablet computer, a notebook computer, a television, an intelligent wearable device, another electronic device with a display screen, or the like. A specific form of the terminal is not limited in the foregoing embodiments. Systems that can be carried on the terminal may include iOS®, Android®, Microsoft®, Linux®, or other operating systems. This is not limited in the embodiments of this disclosure.

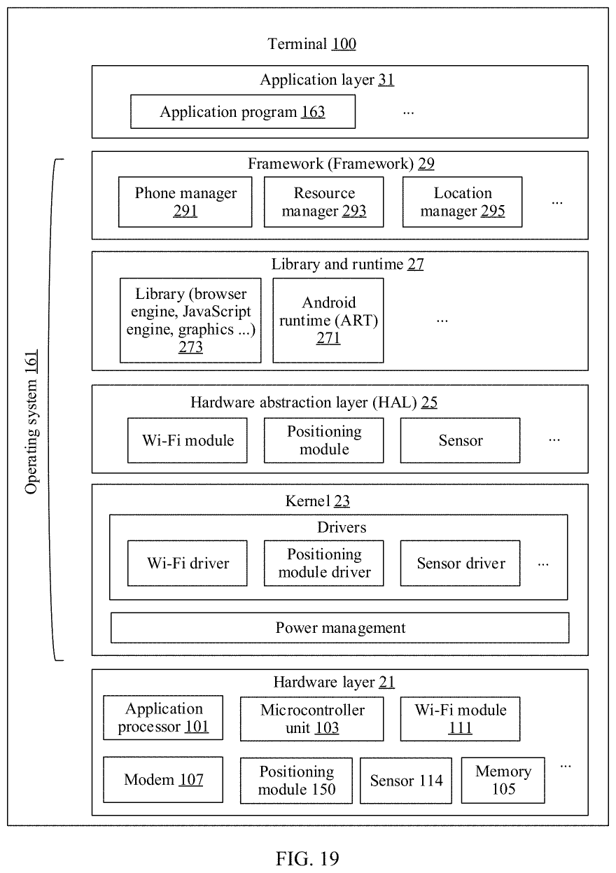

For example, a terminal 100 carrying an Android® operating system is used as an example. As shown in FIG. 19, the terminal 100 may be logically divided into a hardware layer 21, an operating system 161, and an application layer 31. The hardware layer 21 includes hardware resources such as an application processor 101, a microcontroller unit 103, a modem 107, a Wi-Fi module 111, a sensor 114, a positioning module 150, and a memory 105. The application layer 31 includes one or more application programs, for example, an application program 163. The application program 163 may be any type of application program such as a social application, an e-commerce application, or a browser. The operating system 161 serves as software middleware between the hardware layer 21 and the application layer 31, and is a computer program for managing and controlling hardware and software resources.

In an embodiment, the operating system 161 includes a kernel 23, a hardware abstraction layer (HAL) 25, a library and runtime layer 27, and a framework 29. The kernel 23 is configured to provide underlying system components and services, for example, power management, memory management, thread management, and hardware drivers. The hardware drivers include a Wi-Fi driver, a sensor driver, a positioning module driver, and the like. The hardware abstraction layer 25 encapsulates a kernel driver and provides an interface for the framework 29, to shield underlying implementation details. The hardware abstraction layer 25 runs in user space, and the kernel driver runs in kernel space.

The library and runtime 27 is also referred to as a runtime library, and provides a library file and an execution environment that are required during a runtime of an executable program. The library and runtime 27 includes an Android runtime (ART) 271, a library 273, and the like. The ART 271 is a virtual machine or a virtual machine instance that can convert bytecode of an application program into machine code. The library 273 is a program library that provides support for an executable program during a runtime, and includes a browser engine (for example, webkit), a script execution engine (for example, a JavaScript engine), a graphics processing engine, and the like.

The framework 29 is configured to provide the application program at the application layer 31 with various basic common components and services, for example, window management and location management. The framework 29 may include a phone manager 291, a resource manager 293, a location manager 295, and the like.

Functions of the foregoing components of the operating system 161 may be implemented by the application processor 101 executing a program stored in the memory 105.

A person skilled in the art can understand that the terminal 100 may include fewer or more components than those shown in FIG. 19, and the terminal shown in FIG. 19 includes only components more related to the plurality of embodiments disclosed in the embodiments of this disclosure.

Usually, the terminal supports installation of a plurality of applications (APPs), for example, a text processing application program, a phone application program, an email application program, an instant messaging application program, a photo management application program, a web browser application program, a digital music player application program, and/or a digital video layer application program.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this disclosure, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this disclosure essentially, or the part contributing to the prior art, or all or some of the technical solutions may be implemented in the form of a software product. The software product is stored in a storage medium and includes several instructions for instructing a computer device (which may include a personal computer, a server, or a network device) to perform all or some of the operations of the methods described in FIG. 2 to FIG. 16 in the embodiments of this disclosure. The foregoing storage medium includes: any medium that can store program code, such as a USB flash drive, a removable hard disk, a read-only memory (ROM), a random access memory (RAM), a magnetic disk, or an optical disc.

In conclusion, the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of the embodiments of this disclosure.

1. A method, comprising:
obtaining a first sample frame in a panoramic video data;
determining at least one key object in the first sample frame;
obtaining input data;
determining a tracked object in the at least one key object based on the input data, wherein the tracked object corresponds to tracking data;
obtaining three-dimensional location information of the tracked object in the panoramic video data; and
adding the tracking data for the tracked object based on the three-dimensional location information.

2. The method of claim 1, wherein obtaining the three-dimensional location information of the tracked object in the panoramic video data comprises:
determining coordinates of the tracked object in the panoramic video data;
determining a depth value of the tracked object based on the coordinates of the tracked object in the panoramic video data; and
determining the three-dimensional location information of the tracked object in the panoramic video data based on depth information and the coordinates of the tracked object in the panoramic video data.

3. The method of claim 2, wherein determining the depth value of the tracked object comprises:
extracting the depth information based on a pixel value in the panoramic video data; and
determining the depth value of the tracked object based on the depth information.

4. The method of claim 2, wherein determining the depth value of the tracked object comprises:
determining an offset between a left-eye-view image of the tracked object in the panoramic video data and a right-eye-view image of the tracked object in the panoramic video data; and
calculating the depth value of the tracked object based on the offset.

5. The method of claim 4, wherein determining an offset between the left-eye-view image of the tracked object in the panoramic video data and the right-eye-view image of the tracked object in the panoramic video data comprises:
determining an offset corresponding to each pixel of the tracked object in the left-eye-view image in the panoramic video data and the right-eye-view image in the panoramic video data; and
calculating the depth value of the tracked object based on the offset comprises:
calculating each depth sub-value corresponding to each pixel based on the offset corresponding to each pixel; and
performing a weighting operation on each depth sub-value to obtain the depth value of the tracked object.

6. The method of claim 5, wherein performing the weighting operation on each depth sub-value to obtain the depth value of the tracked object comprises:
determining at least one pixel corresponding to a preset feature of the tracked object;
determining a first weight value corresponding to the at least one pixel, and a second weight value corresponding to a pixel other than the at least one pixel of the tracked object, wherein the first weight value is greater than the second weight value; and
calculating the depth value of the tracked object based on the first weight value, the second weight value, and the depth sub-value.

7. The method of claim 2, wherein determining the at least one key object in the first sample frame comprises:
generating at least one sub-image corresponding to the first sample frame; and
identifying objects in each of the at least one sub-image to obtain the at least one key object corresponding to the first sample frame.

8. The method of claim 7, wherein identifying objects in each of the at least one sub-image to obtain the at least one key object corresponding to the first sample frame comprises:
identifying the objects comprised in each of the at least one sub-image; and
determining, based on a preset condition, the at least one key object in the objects comprised in each sub-image.

9. The method of claim 1, further comprising:
generating prompt information for a first key object, wherein the first key object is prompt information for any one of the at least one key object; and
displaying the prompt information.

10. A terminal, comprising:
a processing unit, configured to obtain a first sample frame in a panoramic video data, wherein
the processing unit is further configured to determine at least one key object in the first sample frame; and
an input unit, configured to obtain input data, wherein
the processing unit is further configured to determine a tracked object in the at least one key object based on the input data, wherein the tracked object corresponds to tracking data;
the processing unit is further configured to obtain three-dimensional location information of the tracked object in the panoramic video data; and
the processing unit is further configured to add the tracking data for the tracked object based on the three-dimensional location information.

11. The terminal of claim 10, wherein to obtain the three-dimensional location information of the tracked object in the panoramic video data, the processing unit is further configured to:
determine coordinates of the tracked object in the panoramic video data;
determine a depth value of the tracked object based on the coordinates of the tracked object in the panoramic video data; and
determine the three-dimensional location information of the tracked object in the panoramic video data based on depth information and the coordinates of the tracked object in the panoramic video data.

12. The terminal of claim 11, wherein to determine the depth value of the tracked object, the processing unit is further configured to:
extract the depth information based on a pixel value in the panoramic video data; and
determine the depth value of the tracked object based on the depth information.

13. The terminal of claim 11, wherein to determine the depth value of the tracked object, the processing unit is further configured to:
determine an offset between a left-eye-view image of the tracked object in the panoramic video data and a right-eye-view image of the tracked object in the panoramic video data; and
calculate the depth value of the tracked object based on the offset.

14. The terminal of claim 11, wherein to determine the at least one key object in the first sample frame, the processing unit is further configured to:
generate at least one sub-image corresponding to the first sample frame; and
identify objects in each of the at least one sub-image to obtain the at least one key object corresponding to the first sample frame.

15. The terminal of claim 14, wherein to generate the at least one sub-image corresponding to the first sample frame, the processing unit is further configured to:
generate a left-view three-dimensional panoramic image based on a left-eye-view image in the first sample frame, and generate a right-view three-dimensional panoramic image based on a right-eye-view image in the first sample frame; and
capture a sub-image from the left-view three-dimensional panoramic image or the right-view three-dimensional panoramic image of a preset rule, to obtain the at least one sub-image.

16. The terminal of claim 14, wherein to identify objects in each of the at least one sub-image to obtain the at least one key object corresponding to the first sample frame, the processing unit is further configured to:
identify the objects comprised in each of the at least one sub-image; and
determine, based on a preset condition, the at least one key object in the objects comprised in each sub-image.

17. The terminal of claim 16, wherein before the processing unit generates the at least one sub-image corresponding to the first sample frame, the processing unit is further configured to:
determine every N^{th} frame in the panoramic video as a sample frame, to obtain at least one sample frame, wherein N is a positive integer, and the first sample frame is any one of the at least one sample frame.

18. The terminal of claim 10, wherein the terminal further comprises a display unit, wherein
the processing unit is further configured to generate prompt information for a first key object, wherein the first key object is prompt information for any one of the at least one key object; and
the display unit is configured to display the prompt information.

19. A non-transitory computer-readable storage medium, comprising instructions, wherein when the instructions are performed by a computer, the computer is enabled to perform:
obtaining a first sample frame in a panoramic video data;
determining at least one key object in the first sample frame;
obtaining input data;
determining a tracked object in the at least one key object based on the input data, wherein the tracked object corresponds to tracking data;
obtaining three-dimensional location information of the tracked object in the panoramic video data; and
adding the tracking data for the tracked object based on the three-dimensional location information.

20. The non-transitory computer-readable storage medium of claim 19, wherein the computer further performs:
determining coordinates of the tracked object in the panoramic video data;
determining a depth value of the tracked object based on the coordinates of the tracked object in the panoramic video data; and
determining the three-dimensional location information of the tracked object in the panoramic video data based on depth information and the coordinates of the tracked object in the panoramic video data.
